(19) United States
(12) Patent Application Publication
(10) Pub. No.: US 2004/0028808 A1
(43) Pub. Date: Feb. 12, 2004

(54) Liquid additive spray injection to polymeric powders

(76) Inventors: Charles F. Williams, Strongsville, OH (US); Frederick P. Boyle, Kirtland, OH (US); William P. Taylor, Mentor, OH (US); Paul P. Walsh, Mentor, OH (US)

Correspondence Address: The Lubrizol Corporation, Patent Administrator, Mail Drop 022B, 29400 Lakeland Boulevard, Wickliffe, OH, 44092-2298, US

(21) Appl. No.: 10/380,263

(22) PCT Filed: Sep. 13, 2001
(86) PCT No.: PCT/US01/28515

(51) Int. Cl. B05D 1/12

(52) U.S. Cl. 427/180; 427/421

(57) ABSTRACT

An improved method and apparatus for adding relatively small amounts of one or more liquid additives to powder coating composition where the liquid is sprayed onto granular or particulate components of the powder composition during mechanical mixing to blend the components before further homogenizing by a melt mixing process.

### FIELD OF THE INVENTION

The present invention relates to a method and apparatus for adding liquid additives to powder coating compositions and similar powders. In a preferred embodiment it relates to adding small metered amounts (e.g. less than 5 wt. % based on the weight of the powder) of liquid additives to components of powder coating compositions, such that the liquid additives are relatively uniformly and evenly distributed into the components with minimal additional powder mixing time.

### DESCRIPTION OF THE RELATED ART

The use of additives to achieve desired properties of powder coating compositions is well known. Additives, typically added in relatively small amounts, are used to improve flow properties, transfer efficiency, functional, aesthetic and environmental performance, and other characteristics of the powder coating compositions either during processing or in application. Two excellent sources describing a broad range of coatings technology are Protective Coatings—Fundamentals of Chemistry and Compositions by Clive H. Hare, Technology Publishing Company, Pittsburgh, Pa. (1994), and Powder Coatings by Josef H. Jilek, published by Federation of Societies for Coatings Technology, Darlene Brezinski & Thomas J. Miranda, Eds. (1993).

Typically a powder coating composition is made by first a simple addition and blending all components, including additives, in a mechanical mixer. The mechanical mixing provides some size reduction of the components, but primarily serves to achieve a blend of components for feeding into a heated extruder or other melt processing blender for further homogenization. The heated extruder, or other blender, output is fragmented into a granular form that is then milled into a powder that is applied, as a powder, to the surface to be coated. The powder on the coated surface is then heated to flow and, in some cases, chemically react the powders to produce the finished coating. To achieve optimized coating properties, all powder coating composition components must be uniformly distributed in the finished coating. Also to optimize coating properties, the heat applied to the individual components and ultimate composition during the powder making process must be minimized to prevent degradation of the individual components and chemical interaction of the components during the process. This is particularly important for thermoset powders that are chemically reacted or cured after the powder is applied as a coating. To optimize the cost effectiveness of the manufacturing processing time and any additional preparation of the components for blending must be minimized.

The simple addition and blending of components in a mechanical mixer to achieve relatively uniform component blend of components before melt homogenization works well for components that are solids in their neat form. However, many additives that are of value in powder coating compositions are liquids in their neat form. The uniform distribution of liquid additives in powder coating compositions has been problematic. Specifically, liquid additives in relatively small amounts, when poured directly into a mechanical mixer for blending are difficult to get homogeneously distributed through the powder coating.

In the case where the liquid additive is compatible with and readily swells one or more composition components of the powder coating, the poured liquid additive can be disproportionately present in a small percentage (e.g. 1 wt. %) of the starting material with which it makes initial contact. While this small percentage of powder swollen with the additive may be further dispersed in subsequent steps, the liquid typically does become fully homogeneously distributed, and undesirable variations in coating properties are not uncommon.

In the case where the liquid additive is not compatible with one or more of the other composition components, the poured liquid additive tends to remain as relatively large domains of a separate liquid phase. These large domains of liquid can be smeared over the solid components granular or particulate surfaces; however, intensive mechanical mixing with increased mixing time and/or energy input is needed. Increased mixing adds to the cost of powder production due to reduced process throughput, and increases the temperature seen by the composition components during blending; both being undesired side effects of the increased mixing.

One method for limiting the amount of increased mixing in general plastic processing for poured liquid additives that are not compatible with one or more of the other composition components is to use a non-reactive diluent to reduce the viscosity of the liquid additive before being poured onto the mechanical mixer. This method has the added cost of the diluent, and there are typically other issues, both process and environmental, associated with the release of the diluent during one or more steps of the powder making process.

Either diluted or undiluted, the direct pouring of liquid additives into a mechanical mixer has the added problem of blender clean-up at the end of mixing. While smearing the liquid additive onto the solid components' granular or particulate surfaces, the mechanical mixing also transfers significant liquid additive onto the surfaces of the mixer. This results in loss of the additive in the final composition and increases the clean-up time for the mixer between processing of individual batches. Typically, an additional amount of liquid additive is used when filling the mechanical mixer to compensate for the loss.

One method to over come the problems of direct addition of liquid additives to the mechanical mixer is to, as a separate step, absorb the liquid additive into particulate materials like silica. The liquid additive containing silica behaves as a solid in the mechanical mixing and the liquid additive is at least partially released in the subsequent powder making steps. Issues with this method of liquid additive addition, is that added absorption step adds cost, a greater amount of liquid additive is needed since not all the additive is released by the silica during the powder making process, and the silica generally reduces gloss in subsequent coatings and can serve as a nucleation site for surface defects.

The known prior art does not provide an easily controlled, costeffective method to achieve a highly homogeneous distribution of a relatively small amount of liquid additive into a powder coating composition. As used herein liquid or liquids mean any material that can easily flow and be formed into droplets in the devices described herein.

### SUMMARY OF THE INVENTION

The present invention relates to an improved method and apparatus for dispersing a relatively small amount of liquid additive into a powder coating composition by spraying droplets of liquid additive onto granular or particulate powder coating composition components during mechanical mixing before the components are further homogenized by melt processing.

A feature of the invention is that the droplets neither result in large domains of separate liquid that require increased mixing for uniform transfer and dispersion, nor are droplets lost in significant amounts by adherence to the mechanical mixer or elsewhere during component mixing or transport.

Another feature of the invention is that a non-reactive diluent is not added to the liquid additive to reduce application viscosity.

Another feature of the invention is that the liquid additive is not first absorbed into a particulate solid diluent before mechanical blending of the powder composition components.

Another feature of the invention is that a controller can be used to automate the method of spraying the liquid additive droplets onto the solid component granules or particulate during mechanical mixing.

Another feature of the invention is that a controller can control the amount of liquid additive added during the mechanical mixing process.

Another feature of the invention is that a controller can control the timing and rate of liquid additive addition during the mechanical mixing process.

Another feature of the invention is that a controller can control the temperature of the liquid additive to optimize the flow properties of the liquid additive during the spray process.

Another feature of the invention is that the liquid additive packaging can include information that is automatically inputted into a controller to optimize the process of spraying the liquid additive during mechanical mixing.

Another feature of the invention is that a controller can automatically document and report the liquid additive type, amount and/or process parameter used to spray the liquid additive during the mechanical mixing of a particular composition.

Another feature of the invention is that the liquid additive can be sprayed by pressurizing the additive.

Another feature of the invention is that the fluid can be sprayed using a gas assisted spray nozzle.

Another feature of the invention is that the liquid additive can be sprayed by pressurizing the additive and using a gas assisted spray nozzle.

Another feature of the invention is that the apparatus allows liquid additives to be easily exchanged when preparing different powder coating compositions using the same mixing apparatus.

Another feature of the invention is that the apparatus allows liquid additives to be easily replenished when preparing powder-coating compositions.

The foregoing and other aspects and features of the invention will become apparent from the following description made with reference to the drawings.

### BRIEF DESCRIPTION OF THE DRAWINGS

FIG. 1 is a schematic illustration of current equipment used to mechanically blend and melt homogenize components of powder coating compositions.

FIG. 2 is a schematic illustration of the specific components of an invention embodiment where a gas assisted spray nozzle is used to spray the liquid additive.

FIG. 3 is a schematic illustration of another invention embodiment where the liquid additive is pressurized using a pump to spray the liquid additive.

FIG. 4 is a schematic illustration of another invention embodiment where the liquid additive is pressurized using a gas to spray the liquid additive.

FIG. 5 is a schematic illustration of another invention embodiment where the liquid additive is pressurized using a driven ram to spray the liquid additive.

FIG. 6 is a schematic illustration of another embodiment of the present invention for spraying liquid additives using two liquid additive reservoirs.

FIG. 7 is a schematic illustration of a controller embodiment that controls the method and apparatus of the invention including means to input information needed for control, and to output information to document the liquid additive spray process during mechanical mixing.

### DETAILED DESCRIPTION OF THE INVENTION

The invention relates to an improved method and apparatus for dispersing a relatively small amount of liquid additive, typically less than 5% of the total weight of a powder composition, preferably a powder coating composition, during mechanically mixing the solid, granular or particulate, components of the powder composition. A liquid additive is defined here as a chemical compositions that has a desirable effect on the powder composition and is a liquid or a soft solid (having a relatively low yield stress) at 25° C., such that it is not readily added as a granular or particulate solid at 25° C.

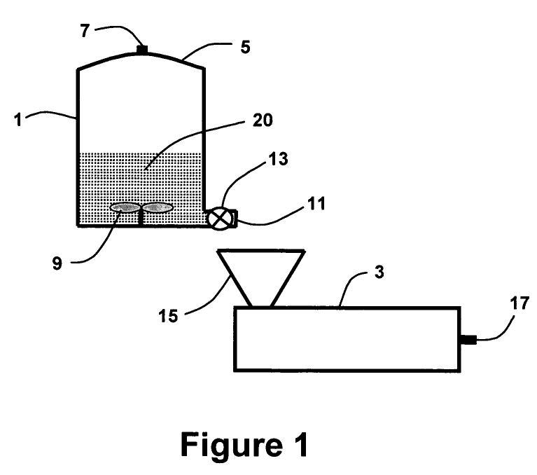

For a better understanding of the current methods of adding liquid additive into a powder coating composition, reference is made to FIG. 1. Shown are a convention mechanical mixer 1 and a conventional heated extruder 3. Mechanical mixer 1 includes top 5 with closable port 7, mixing blade 9, and drain 11 with valve means 13. Heated extruder 3 has input hopper 15 and output 17.

To prepare a powder coating composition, top 5 of mechanical mixer 1 is opened, and valve means 13 of drain 11 is closed. Determined amounts of the composition's individual solid granular or particulate components are placed into mixer 1 and are shown collectively as 20. In the case where one or more additives in liquid form are required as components for the composition, there are two prior methods of adding the liquid to mechanical mixer 1. One method is to pour the liquid(s) into mechanical mixer 1 after the granular or particulate solids are added. In this procedure, after adding the liquid additives, top 5 is closed and secured, and a controller and drive (not shown) is used to rotate mixing blade 9 at predetermined speed(s) for predetermined time(s). The purpose of the mixing is to blend of solid components 20 and the liquid additive(s). Also during mixing some size reduction of the solid granules and particulate may occur. Another prior method for adding the liquid additives, is to close and secure top 5 of mechanical mixer 1 after solid components 20 are placed into the mixer, start the rotation of blade 9, and pour the liquid additive(s) into mechanical mixer 1 through port 7 in top 5 as blade 9 is blending, and possibly size reducing the components.

Components 20, including the liquid additive, may be heated during the mechanical mixing due to the energy input of the mixing process. In many mixers, a liquid cooling jacket (not shown) surrounds the surface of mechanical mixer 1 in an attempt to minimize heating during mixing. Typically, mechanical mixer 1 has vents to allow release of any pressure buildup that may occur due to heating. In the case where diluents are used to reduce the viscosity of a liquid additive component, the diluent may also be vented during mixing.

At the completion of the mechanical mixing cycle, valve means 13 is opened allowing blended components 20 to exit drain 11 of mechanical mixer 1 and to be received by hopper 15 of heated extruder 3. In some embodiments hopper 15 directs blended components 20 into the feed zone of a screw mechanism (not shown) of extruder 3, which transports the mechanical mixer output through the extruder where the powder coating composition components are melted and further homogenized. The material exits heated extruder 3 at output 17 where the material is cooled, fractured and ground into powder using equipment not shown.

When the production of one powder coating composition is completed, mechanical mixer 1 and extruder 3 are cleaned in preparation of producing the next composition.

It should be noted that while FIG. 1 has schematic illustration of one type of mechanical mixer 1, any one of a variety of batch or continuous mechanical mixers may be use for mechanical blending composition components, for example Henschel, Hobart, fluidized bed, or ribbon blenders. Similarly while heated extruder 3 is shown in FIG. 1, a variety of melt processing equipment can be used to achieve a homogeneous composition, for example Banbury mixers, Brabender mixers, multi-roll mills, heated Sigma blade mixers etc.

For any mechanical mixer 1, and for any melt processing equipment 3, the practice of pouring relatively small amounts of liquid additives onto the solid composition components 20 in mechanical mixer results in, poor dispersion of the additive, the need for increased mechanical mixing time and/or energy, the need for increased clean-up time due to loss of the additive on the surface of mechanical mixer and material transfer equipment (not shown), the need for increased amount of liquid additive to compensate for additive loss, or a combination of these undesirable consequences. These limitations and others of the prior method of adding relatively small amounts of liquid additives to powder coating composition are overcome with the present invention.

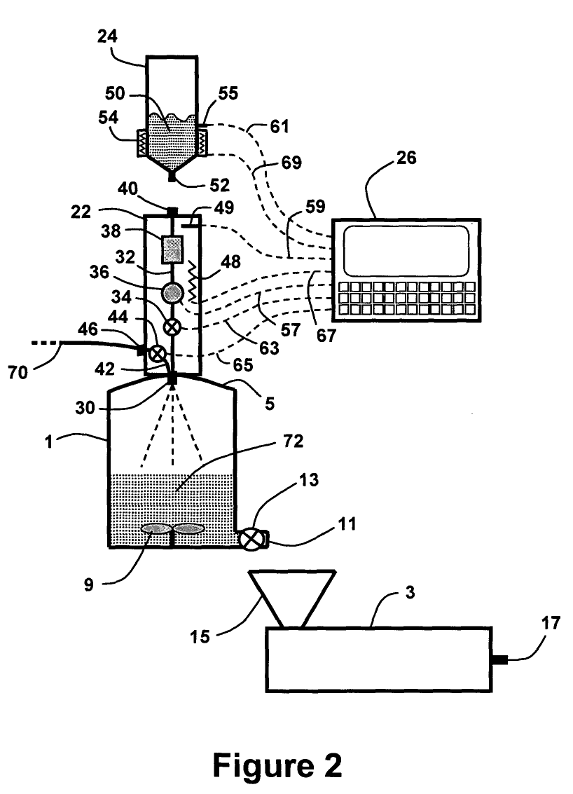

FIG. 2 is a schematic illustration of a first embodiment of the apparatus of this invention that is in addition to the prior mechanical mixer 1 and heated extruder 3. Heated extruder 3 is the same as shown in FIG. 1 with input hopper 15, and output 17, and mechanical mixer 1 includes top 5, mixing blade 9, and drain 11 with valve means 13. The apparatus of the present invention includes spray assembly 22, liquid additive reservoir 24 and controller 26. The spray assembly 22 is mounted on top 5 of mechanical mixer 1 and includes spray nozzle 30 that communicates with the interior of mechanical mixer 1, conduit 32 with flow control valve 34, meter 36 and optional filter 38 that communicates liquid from inlet connector 40 to spray nozzle 30, conduit 42 with flow/pressure control valve 44 that communicates pressurized gas from inlet 46 to spray nozzle 30, heater 48 and thermocouple 49. Liquid additive reservoir 24 includes liquid additive 50, connector 52 that is normally closed to prevent additive loss from the reservoir unless mated in a leak free manner to connector 40 on spray assembly 22, removable heater 54 and thermocouple 55. Controller 26 includes inputs 57, 59, and 61 from meter 36 and thermocouples 49 and 55 respectively, and outputs 63, 65, 67 and 69 to flow control valve 34, flow/pressure control valve 44 and heaters 48 and 54 respectively. Conduit 70 is from a pressurized gas source (not shown) and mates in a leak free manner with inlet 46 of spray assembly 22.

In a typical operation, to blend powder coating composition components that include at least one liquid additive, top 5 of mechanical mixer 1 is opened, and valve means 13 of drain 11 is closed. Determined amounts of the composition's individual solid granular or particulate components, shown collectively as 72, are placed into mixer 1 and cover 5 securely closed. Liquid additive reservoir 24 with appropriate liquid additive, or blend of liquid additives, 50 for the desired composition is connected, using connector 52, in a leak free manner with connector 40 of spray assembly 22, and heater 54 and thermocouple 55 placed on the reservoir. Information is entered into controller 26 that determines the amount, rate and timing of liquid additive 50 addition that is to occur during the composition components blending in mechanical mixer 1, and determines the temperature required for liquid additive 50 in reservoir 24 and the temperature of spray assembly 22.

Using entered information, if controller 26, using inputs 59 and 61 from thermocouples 49 and 55 respectively determines the temperature of liquid additive 50 or of spray assembly 22 is below the required temperature, using outputs 67 and 69, controller 26 selectively powers heaters 48 and 54 respectively to achieve and maintain the determined temperatures. When controller 26 determines the temperatures are at or above the determined temperatures, the controller signals, using a light, an alpha/numeric display, or another signaling device (not shown), that the apparatus is ready for component blending. Seeing the signal, a mixer operator begins the mixing process by giving an input to a second controller (not shown) that starts and controls the rotation speed(s) and timing(s) of mixing blade 9. At the same time, the mixer operator gives an input to controller 26 to indicate the start of the mixing cycle. Although not shown, controller 26 can have a communication conduit to the drive controller and/or a remote controller so that only one input is needed by an operator, or another control means, to start the mixing cycle. During the mixing cycle, controller 26 controls flow valve 34 and flow/pressure valve 44 while monitoring flow meter 36 to control the timing, rate, and amount of liquid additive 50 added to solid granular or particulate composition components 72 during the mixing process.

The temperature of liquid additive reservoir 24, the temperature of nozzle assembly 22, the flow rate of liquid additive 50 and the flow/pressure of the gas communicated to nozzle 30 are controlled by controller 26 to achieve a desired spray droplet size and additive addition rate that is dependent on the orifice size of nozzle 30, size, type and mixing parameters of mechanical mixer 1, composition batch size, and physical and chemical properties of liquid additive 50. In general, the spray droplet size must be small enough to allow droplets to adhere to a significant percentage of the solid granular or particulate components 72 in mechanical mixer 1 for a relatively uniform distribution of the additive without the need for additional mixing to transfer liquid additive between solid particles. The spray droplet size, however must be sufficiently large to assure that the droplets quickly drop out of the gas within the mechanical mixer and onto the solid particles so that gas-borne droplets are not lost due to adhesion to the surfaces of the mixer. While the optimum mean droplet diameter is primarily dependent on the particular liquid additive or liquid additive blend 50, in general, controller 26 maintains the temperatures, flow rates and pressures to desirably achieve a number average spray droplet diameter from about 1 to 200 microns, more desirably from about 5 to 200 microns, and preferably from about 5 or 10, 15, 20, 30 or 40 microns.

In addition to controlling for spray droplet size, the controller 26 controls the rate of liquid additive 50 addition to assure that the addition rate is sufficiently slow to adhere additive droplets to a large number of the solid particles 72 as they are transported past the spray pattern of spray nozzle 30 during mechanical mixing, but is sufficiently fast to transfer the required amount of additive during the mixing process.

Another consideration for the variables controlled by controller 26 is that while elevated temperature of additive liquid reservoir 24 may be need to allow sufficiently rapid flow of liquid additive 50 into spray assembly 22, and elevated temperature of spray assembly 22 may be needed to reduce the liquid viscosity for desired spray droplet size, the liquid additive 50 temperature and time of exposure to temperature must be minimized to reduce the possible chemical degradation of the additive. In general, reservoir 24 is heated only to a temperature conducive to have the additive flow at a desired spray rate into spray assembly 24, and the temperature of spray assembly 22 is sufficient high to achieve the desired droplet size. Ideally, the size of spray assembly 22 is minimized so that only a small volume of liquid additive is in the spray assembly, thereby minimizing additive residence time and minimizing the heating and cooling times for spray assembly 22. Minimizing heating and cooling times allows minimizing any thermal degradation of additive 50 that remains in spray assembly 22 between composition batches. In general, the size of spray assembly 22 is such that desirably the volume of liquid additive in the spray assembly is less than 10% of the total volume of reservoir 24, more desirably less than 5% of the reservoir volume, and preferably less than 1% of the volume. Reducing the size of spray assembly 22 has the added advantage of minimizing additive waste and clean-up time when subsequent composition batches require different liquid additive or blend of liquid additives.

At the end of the mixing cycle, when liquid additive addition and mechanical mixing is complete, mixing blade 9 of mechanical mixer 1 is turned “off”, and, unless commanded otherwise, controller 26 removes power from heaters 48 and 54 to return liquid additive 50 to room temperature. Valve means 13 of drain 11 is opened, and the blended powder coating composition components transferred into hopper 15 of heated extruder 3 for further melt homogenization. In this manner, the relatively small amount of liquid additive 50 is blended with the solid granular or particulate powder coating composition components without the limitations of prior liquid additive addition methods.

Between the completion of mechanically blending one batch of powder coating composition components and the next batch, top 5 of mechanical mixer 1 is opened. If the next powder coating composition batch requires the same liquid additive 50 contained in additive reservoir 24, then the additive reservoir 24 remains mated to connector 40 of spray assembly 22. If the next powder coating composition batch requires either no liquid additive or a different liquid additive or additive blend, liquid reservoir 24 is removed from the apparatus by removing heater 48 and thermocouple 55, and disconnecting connector 52, without loss of liquid, from connector 40 of spray assembly 22. Spray assembly 22 is cleaned using either a pressure gas and/or liquid conduit (not shown) that connects in a leak free manner to connector 40 and gas and/or liquid is used to purge any remaining liquid additive 50 from spray assembly 22. When spray assembly 22 is cleaned the gas and/or liquid conduit is removed from connector 40. If a liquid additive or liquid additive blend is required in the next batch, a liquid additive reservoir 24 with required liquid additive 50 is connected to connector 40 of spray assembly 22, heater 54 and thermocouple 55 are installed, new information is entered into controller 26 and the liquid additive application cycle is ready to begin again, including heating the liquid additive reservoir 24 and spray assembly 22 if required.

Note that while spray assembly 22 is shown in FIG. 2 to be essentially permanently attached to top 5 of mechanical mixer 1, and liquid additive reservoir 24 removably connects to spray assembly 22 using connectors 52 and 40 respectively, fluid reservoir 24 and spray assembly 22 could be a single assembly that removably connects to top 5 and has connectors for connecting electrical conduits 57, 59, 61, 63, 65, 67, and 69 from controller 26 and pressurized gas conduit 20. In this configuration, the entire assembly could be removed and, if needed, exchanged if the next batch of powder coating composition does not require the liquid additive of the previous composition. In this manner, there is no need to clean the spray assembly 22 when removing the previous liquid additive.

Note that in FIG. 2 only one spray nozzle 30 in spray assembly 22 is fed by liquid conduit 32 and gas conduit 42. However, that spray assembly 22 can have more than one spray nozzle 30 fed by conduits 32, 42 if increased liquid additive spray rate is needed without negatively affecting spray droplet size, or if a larger spray pattern is needed to efficiently adhere additive droplets to a significant percentage of the granular or particulate solid components during additive addition.

Note that while spray assembly 22 of FIG. 2 is shown only with a heater 54 for temperature control, it is within the scope of this invention that the spray assembly 22 can also have a cooling element controlled by controller 26 as a viscosity control means or to rapidly cool spray assembly 22 to room temperature or below to minimize any thermal degradation of liquid additive 50 remaining in assembly 22 between spray applications.

An issue with the use of the gas spray nozzle used in the embodiment of FIG. 2, is that though only a small amount of additive, and therefore gas, is used during the spraying process, any volume added to the mechanical mixer during component blending increases need to vent gas during mixing. It is desirable to minimize the amount of gas vented during mixing.

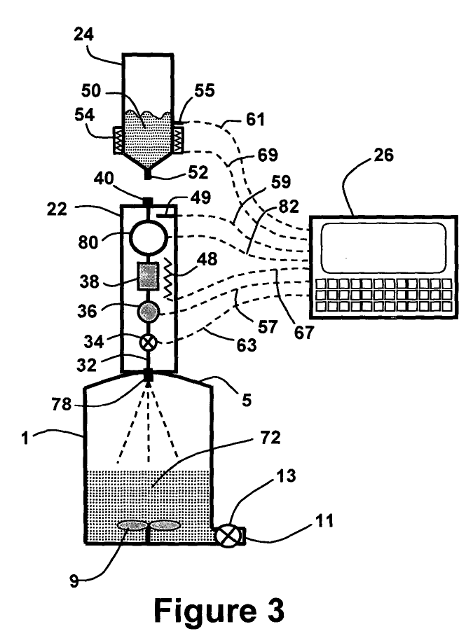

FIG. 3 is a schematic illustration of another embodiment of the apparatus of this invention that uses an airless spray nozzle for use with low viscosity liquid additives. The apparatus is mounted on cover 5 of mechanical mixer 1, and includes spray assembly 22, liquid additive reservoir 24, and controller 26. Spray assembly 22 includes airless spray nozzle 78 that communicates with the interior of mechanical mixer 1, conduit 32 with flow control valve 34, meter 36, optional filter 38 and pump 80 that communicates liquid from connector 40 to spray nozzle 78, heater 48 and thermocouple 49. Liquid additive reservoir 24 is the same as shown in FIG. 2. Controller 26 includes inputs 57, 59, 61 from meter 36 and thermocouples 49 and 55 respectively, and outputs 63, 67, 69 and 82 to flow control valve 34, heaters 48 and 54 and pump 80 respectively.

In operation, determined amounts of the composition's solid granular or particulate components, shown collectively as 72, are placed in mechanical mixer 1 and cover 5 securely closed, and liquid additive reservoir 24 with appropriate liquid additive or liquid additive blend 50 is connected, using connector 52, in a leak free manner with connector 40 on spray assembly 22, and heater 54 and thermocouple 55 placed on the reservoir. Information is entered into controller 26 that determines the amount, rate and timing of liquid additive 50 addition, and the temperatures required for liquid additive reservoir 24 and spray assembly 22. If required, controller 26 heats reservoir 24 and/or spray assembly 22, and when the temperatures are at or above the determined temperatures, controller 26 gives a signal that the apparatus is ready for component blending.

A mixer operator or other means begins the mixing process rotating the mixing blade 9 and beginning the timing of controller 26. During the mixing cycle, controller 26 controls flow valve 34 and pump 80 while monitoring flow meter 36 to control the timing, rate and amount of liquid additive 50 added to solid granular or particulate composition components 72 during the mixing process.

Controller 26, using determined temperature, pressure and flow rate values that are dependent on the orifice size of spray nozzle 78, size, type and mixing parameters of mechanical mixer 1, composition batch size, and the physical and chemical properties of liquid additives 50, accurately controls heaters 48, 54, pump 80 and flow valve 34 to achieve a liquid additive droplet size and addition rate, as described in the operation of the embodiment shown in FIG. 2. As before, the control variables are determined and spray assembly 22 is designed to minimize the heating of liquid additive 50 both in additive reservoir 24 or in spray assembly 22.

At the end of the mechanical mixing cycle, when liquid additive addition and mechanical mixing is complete, mixing blade 9 of mechanical mixer 1 is turned “off”, and unless commanded otherwise, controller 26 removes power from heaters 48 and 54 to return liquid additive 50 to room temperature. Valve 13 of drain 11 is opened, and the blended powder coating composition components are transferred to the input of a heated extruder (not shown) for further homogenization. In this manner, the relatively small amount of liquid additive 50 is blended with the solid granular or particulate powder coating composition components without the limitations of prior liquid additive addition methods.

Between the completion of mechanically blending one batch of powder coating composition components and the next batch, top 5 of mechanical mixer 1 is opened. If the next powder coating composition batch requires either no liquid additive or a different liquid additive or additive blend, liquid reservoir 24 is removed from the apparatus by removing heater 48 and thermocouple 55, and disconnecting connector 52, without loss of liquid, from connector 40 of spray assembly 22. Spray assembly 22 may be cleaned by connecting a cleaning-fluid conduit (not shown) to connector 40, and then, using controller 26 and output wire 82 power pump 80 to pump cleaning-fluid through the spray assembly 22. When spray assembly 22 is cleaned the cleaning-fluid conduit is removed from connector 40. If a liquid additive is required in the next batch, a liquid additive reservoir 24 with the required liquid additive or additive blend 50 is connected to connector 40, heater 54 and thermocouple 55 are installed, new information is inputted to controller 26 and the liquid additive application cycle is ready to begin again, including heating the liquid additive reservoir 24 and spray assembly 22 if required.

Note that the meter 36 of the invention embodiment of FIG. 3 could be eliminated if pump 80 is a positive displacement pump that can be controlled by controller 26 to pump determined amounts of liquid additive 50 without the need for feedback from meter 26.

Note that while FIG. 3 shows an airless spray- nozzle 78, a gas assisted spray nozzle with controlled, pressurized gas source (e.g. nozzle 30 with conduit 42, flow/pressure control valve 44, inlet 46 and pressurized gas conduit 70 of FIG. 2), can be included in the embodiment for highly viscous liquid additives that cannot be sprayed with sufficiently small droplet size with airless spraying alone. Further note that more than one airless or gas assisted spray nozzle could be used if increased liquid additive spray rate or spray pattern is needed for efficient addition of the liquid additive.

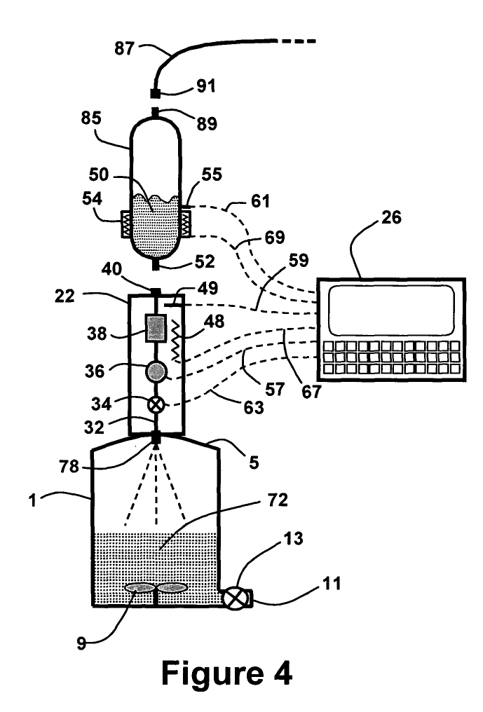

FIG. 4 is a schematic illustration of another invention embodiment mounted on cover 5 of mechanical mixer 1. The embodiment includes spray assembly 22, pressurizable liquid additive reservoir 85, conduit 87, and controller 26. Spray assembly 22 includes airless spray nozzle 78, that communicates with the interior of mechanical mixer 1, and conduit 32 with flow control valve 34, meter 36 and optional filter 38, that communicates liquid from connector 40 to spray nozzle 78. Pressurizable liquid additive reservoir 85 includes liquid additive or liquid additive blend 50, connector 52 that is normally closed to prevent liquid loss from the reservoir unless mated in a leak free manner to connector 40 on spray assembly 22, connector 89 that is normally closed to prevent communication of gas or liquid with the interior of the reservoir unless mated to an appropriate connector, removable heater 54 and thermocouple 55. Conduit 87 communicates pressurized gas from a source (not shown) to a normally closed connector 91 that mates in a leak free manner with connector 89 on pressurizable liquid additive reservoir 85. Controller 26 includes inputs 57, 59 and 61 from meter 36 and thermocouples 49 and 55 respectively, and outputs 63, 67 and 69 to flow control valve 34 and heaters 48 and 54 respectively.

In operation, solid granular or particulate composition components 72 are placed in mechanical mixer 1 and cover 5 securely closed. Pressurizable liquid additive reservoir 85 with the appropriate liquid additive or additive blend 50 is connected, using connector 52, in a leak free manner with connector 40 on spray assembly 22, and, using connector 89, in a leak free manner, with connector 91 of conduit 87. Heater 54 and thermocouple 55 placed on the liquid additive reservoir 85. Information is entered into controller 26 that determines the amount, rate and timing of liquid additive 50 addition, and the temperatures required for reservoir 85 and spray assembly 22. Since liquid additive 50 is now forced from reservoir 85 by the pressurized gas in addition to the gravity feed of the embodiments of FIGS. 2 and 3, the temperature of reservoir 85 can be relatively lower than the temperature required for reservoir 24 in FIGS. 2 and 3. As in the other embodiments, controller 26 gives a signal when the apparatus is ready for component blending.

During the mechanical mixing process, controller 26 controls flow valve 34 while monitoring flow meter 36 to control the timing, rate and amount of liquid additive 50 added to solid composition components 72 as described in the operation of the embodiment shown in FIG. 2. Although not shown, conduit 87 could also include a gas pressure regulating valve that is controlled by a mixer operator, or by controller 26 to better control liquid additive droplet size and application rate.

At the end of the mixing cycle, if required, pressurizable liquid additive reservoir 85 can be removed using connectors 52 and 89, and spray assembly 22 cleaned as in previous embodiments, and a if required for the next powder coating composition batch another pressurizable liquid additive reservoir 85 with appropriate liquid additive or liquid additive blend 50 reattached to the apparatus. In this manner, the relatively small amount of liquid additive 50 is blended with the solid granular or particulate powder coating composition components without the limitations of prior liquid additive addition methods.

Note that the embodiment of FIG. 4 could include a gas assisted spray nozzle with controlled, pressurized gas source (e.g. nozzle 30 with conduit 42, flow/pressure control valve 44, inlet 46 and pressurized gas conduit 70 of FIG. 2) when used with highly viscous liquid additives. Further note that more than one airless or gas assisted spray nozzle could be used if increased liquid additive spray rate or spray pattern is needed for efficient addition of the liquid additive.

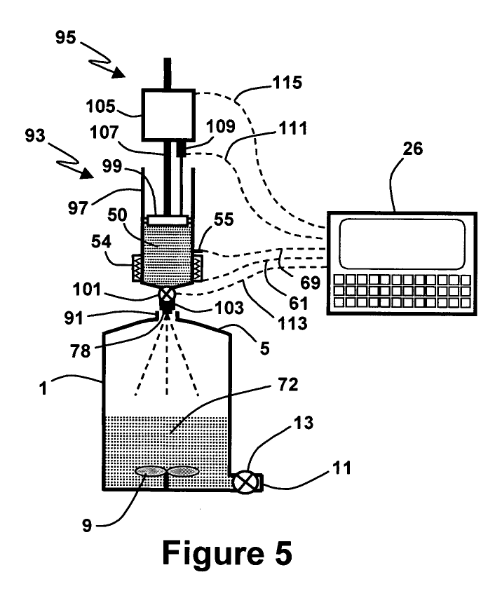

FIG. 5 is a schematic illustration of another invention embodiment that mounts on top 5 of mechanical mixer 1. Top 5 in this embodiment includes connector 91 that is normally closed. The invention apparatus includes liquid additive assembly 93, removable heater 54 and thermocouple 55, ram assembly 95 and controller 26. Liquid additive assembly 90 includes liquid additive or liquid additive blend 50, liquid additive reservoir 97, movable piston 99, flow control valve 101, airless spray nozzle 78 and connector 103. Movable piston 99 separates the liquid additive 50 in reservoir 97 from air in a leak free manner such that when a force is applied to the air side of the piston 99, liquid additive 50 is pressurized with essentially no liquid additive escaping around the piston. Connector 103 mates in a leak free manner with connector 91 on top 5 of mechanical mixer 1. Control valve 101 is normally closed, preventing liquid additive 50 in reservoir 97 from communicating with spray nozzle 78. Ram assembly 95 includes drive 105, ram 107 and linear position sensor 109. Drive 105, on command from controller 26 moves ram 107 in a direction along the axis of the ram, and sensor 109 accurately determines the position of the ram relative to the fixed position of the ram assembly 95. Controller 26 includes inputs 69 and 111 from thermocouple 55 and linear position sensor 109 respectively, and outputs 61, 113 and 115 to heater 48, flow control valve 101 and drive 105 respectively.

In operation, solid granular or particulate composition components 72 are placed in mechanical mixer 1 and cover 5 securely closed. Liquid additive assembly 93, with the appropriate liquid additive or liquid additive blend 50, is connected using connector 103, in a leak free manner to connector 91 on top 5 of mechanical mixer 1. Heater 54 and thermocouple 55 are placed on liquid additive reservoir 97, and output wire from controller 26 is connected to flow control valve 101. During the mounting of liquid additive assembly 93, ram 107 of ram assembly 95 is fully retracted so as not to interfere with mounting the liquid additive assembly 93. Information is entered into controller 26 that determines the amount, rate and timing of liquid additive 50 addition and the temperature required for liquid additive 50 in reservoir 97. Although for illustration purposed, only a single heater 54 and thermocouple 55 for liquid additive reservoir 97 is shown in FIG. 5, the heater and thermocouple can have multiple elements such that the liquid additive reservoir 97 and the combined flow control valve and spray nozzle can be controllably heated to separate temperatures. When controller 26 determines that the temperature(s)of liquid additive assembly 93 is (are) at or above the determined temperature(s) controller 26 powers drive 105 to move ram 107 to contact piston 99 in liquid additive assembly 93, and signals that the apparatus is ready for component blending. When ram 107 contacts piston 99, no liquid additive flows since flow control valve 101 is closed until commanded by controller 26 and essentially no leakage occurs around piston 99.

During the mechanical mixing process, controller 26 controls flow valve 101 and drive 105 while monitoring the position of the ram 107 using linear position sensor 109 to control the timing, rate and amount of liquid additive 50 added to solid composition components 72. Control 26 determines additive volume from linear position of ram 107 and the area of piston 99, which is either a standard area stored in controller 26 or is information entered into controller 26. The control variables are optimized to achieve the desired spray distribution of the liquid additive 50, as described in the operation of the embodiment shown in FIG. 2, while minimizing the heat history of the additive. Since spray nozzle 78 is part of liquid additive assembly 93 with additive 50, the nozzle parameters can be optimized for the particular liquid additive 50 in reservoir 97. While the spray nozzles in embodiments 2-4 can be changed each time a different liquid additive is used, this embodiment more easily mates an appropriate spray nozzle with a specific liquid additive or liquid additive blend 50.

At the end of the additive addition, unless commanded otherwise, controller 26 removes power from heater 54 to return liquid additive 50 to room temperature and powers drive 105 to retract ram 107 from liquid additive reservoir 93. At the completion of mechanical mixing, mixing blade 9 of mechanical mixer 1 is turned “off”, valve means 13 of drain 11 is opened, and the blended powder coating composition components are transferred to the input of a heated extruder (not shown) for further homogenization. In this manner, the relatively small amount of liquid additive 50 is blended with the solid granular or particulate powder coating composition components without the limitations of prior liquid additive addition methods.

Between the completion of mechanical blending one batch of powder coating composition components and the next batch, if required, liquid additive assembly 93 can be removed by disconnecting connecting input wire 113 from flow control valve 101, removing heater 54 and thermocouple 55 and disconnecting connector 103 from connector 91 on top 5 of mechanical mixer 1. Also if required another liquid additive reservoir assembly 93 can be connected for the next powder coating composition batch.

An advantage of the liquid additive reservoir assembly 93 of this embodiment is that there is no need to clean a spray nozzle while attached to top 5 of mechanical mixer 5. Liquid additive reservoir assembly 93 with spray nozzle 78 can be taken to a cleaning station (not shown) where the assembly with reservoir 97, valve 101 and nozzle 78 are cleaned when needed. If a reservoir assembly is always used with only one liquid additive 50, then the need for cleaning is minimized.

Note that a modification of the embodiment shown in FIG. 5 could eliminate linear position sensor 109 if drive 105 is a controllable positive displacement type drive, for example if a stepper motor were used to drive a screw ram a specific distance with each controllable step.

Note that the invention embodiment of FIG. 5 could include a gas assisted nozzle with controlled pressurized gas source (e.g. nozzle 30, conduit 42, flow/pressure control valve 44, inlet 46 and pressurized gas conduit 70 of FIG. 2) when used with highly viscous liquid additives. Further note that more than one airless or gas assisted spray nozzle could be used in the embodiment if increased liquid additive spray rate or spray pattern is needed for efficient addition of the liquid additive.

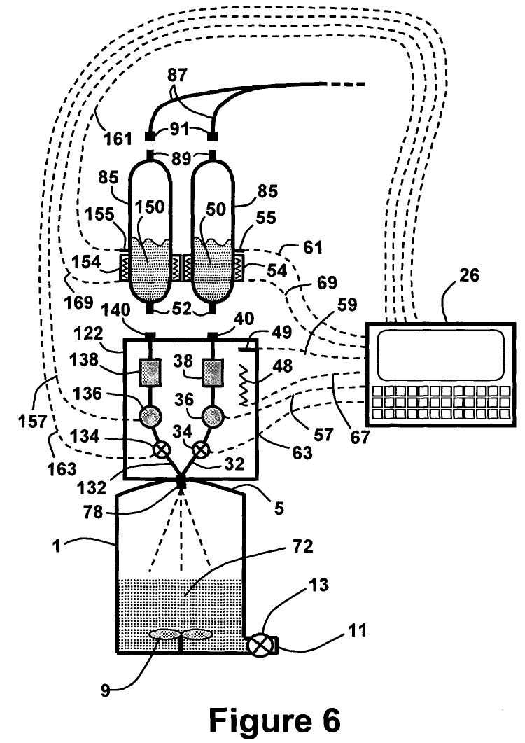

The invention embodiments shown in FIG. 2-5 allow the addition of liquid additive or liquid additive blend 50 from only one liquid additive reservoir. While typically liquid additive can be blended into one reservoir if more than on additive is needed, there may be either chemical or economic reasons why blending additives together is not an appropriate solution and it is desirable to use separate liquid additive reservoirs for the additives. There may also be reason to use separate liquid additive reservoirs for the same additive, for examples, as a fail-safe if one reservoir empties or fails before the required amount of liquid additive is added to the composition, or as one way to increase the rate of additive addition during mechanical mixing. One means for allowing multiple liquid additive reservoirs is to mount multiple apparatus of the types shown in FIGS. 2-5. Another means of allowing for multiple liquid additive reservoirs is shown in FIG. 6.

FIG. 6 is a schematic illustration of another invention embodiment mounted on top 5 of mechanical mixer 1. The embodiment includes spray assembly 122, two pressurizable liquid additive assemblies 85, conduit 87 and controller 26. Spray assembly 122 includes spray nozzle 78, that communicates with the interior of mechanical mixer 1, conduit 32 with flow control valve 34, meter 36 and optional filter 38 that communicates liquid from connector 40 to spray nozzle 78, and conduit 132 with flow control valve 134, meter 136 and optional filter 138 that communicates liquid from connector 140 to spray nozzle 78. The pressurizable liquid additive reservoirs 85 are the same shown in FIG. 4, with one containing liquid additive 50 and the other containing liquid additive 150. Depending on application, liquid additive or liquid additive blend 150 may be the same or different than additive 50. The pressurizable liquid additive reservoir 85 has removable heater 54 and thermocouple 55 if it mounts to connector 40 on spray assembly 122, and has removable heater 154 and thermocouple 155 if it mounts to connector 140. Conduit 87 communicates pressurized gas from a source (not shown) to normally closed connectors 91 that mate in a leak free manner with connectors 89 on pressurizable liquid additive reservoirs 85. Controller 26 includes inputs 57, 157, 59, 61 and 161 from meters 36 and 136 and thermocouples 49, 55 and 155 respectively, and outputs 63, 163, 67, and 69, 169 respectively.

In operation, the pressurizable liquid additive reservoir 85 with one appropriate liquid additive 50 is connected using connector 52, in a leak free manner with connector 40 on spray assembly 122 and heater 54 and thermocouple 55 are added to the reservoir. Reservoir 85 with the other appropriate liquid additive 150 is connected using connector 52, in a leak free manner with connector 140 and heater 154 and thermocouple 155 are added to the reservoir. The reservoirs 85 are also connected, using connectors 89, with connectors 91 of conduit 87. Information is entered into the controller indicating which additive is in the reservoir 85 connected to connector 40 and which additive is in the reservoir 85 connected to connector 140, and other information that is used by controller 26 to determine the amount rate and timing of liquid additive 50 and liquid additive 150 addition, the temperatures required for the two reservoirs and the spray assembly 122. As in other embodiments, controller 26 gives a signal when the temperatures are at the determined values.

During the mechanical blending process, controller 26 controls flow valves 34 and 134, while monitoring flow meters 36 and 136 to control the timing, rate and amount of liquid additives 50 and 150 respectively, to disperse the liquid additives 50 and 150 on solid composition components 72 during the mixing process, as described in the operation of the embodiment shown in FIG. 2.

At the end of the mixing cycle, if required, one or both of the pressurizable liquid additive reservoirs 85 can be removed using connectors 52 and 89, and spray assembly 122 cleaned. Liquid additive reservoirs 85 with different additive(s) can then be mounted if required for the next powder coating composition batch. In this manner, the relatively small amount of liquid additive 50 is blended with the solid granular or particulate powder coating composition components without the limitations of prior liquid additive addition methods.

Note that the embodiment of FIG. 6 could include a gas assisted spray nozzle with controlled, pressurized gas source (e.g. nozzle 30 with conduit 42, flow/pressure control valve 44, inlet 46 and pressurized gas conduit 70 of FIG. 2) when used with highly viscous liquid additives. Further note that more than one airless or gas assisted spray nozzle could be used if increased liquid additive spray rate or spray pattern is needed for efficient addition of the liquid additive.

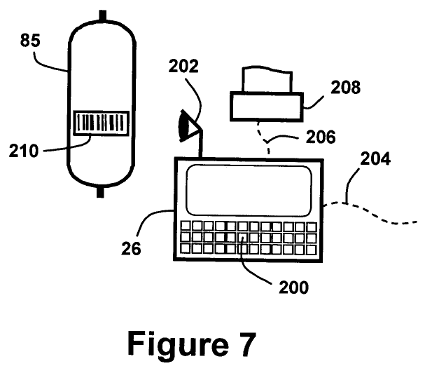

In the description of the operation of the embodiments of FIGS. 2-6, information is entered into controller 26 that determines the amount, rate and timing of liquid additive addition during mechanical mixing of the composition components and determines the temperatures required for the liquid additive to be properly sprayed. FIG. 7 is a schematic illustration of an embodiment of the controller 26 that controls the method and apparatus of the invention. In addition to all of the inputs and output wires shown in embodiments 2-6, which are not shown here, controller 26 optionally includes key board 200, optical reader 202, communication conduit 204 to a remote location, and output 206 to printer 208. In operation, controller requires information to control various apparatus components while monitoring the various apparatus sensors in order to achieve appropriate additive droplet size and appropriate spray rates. For examples, in the embodiment of FIG. 2, the controlled components are heaters 48, 54, flow valve 34, and flow/pressure valve 44, and the sensors are thermocouples 49, 55 and flow meter 36, and in the embodiment of FIG. 5 the controlled components are heater 54, flow valve 101 and drive 105 and the sensors are thermocouple 55 and linear position sensor 109. The entered information can be specific parameters, for example temperatures, volumes, timings, or the information can be specific formulations and volumes, from which the controller determines specific parameters using stored information or process algorithms. Referring again to FIG. 7, the information may be entered into controller 26 using keyboard 200, from a remote location, for example a control station that controls the entire component blending operation, using input 204, and/or by “reading” information contained on a liquid additive reservoir, for example pressurizable liquid additive reservoir 85 shown, used for a particular composition.

As shown in FIG. 7, reservoir 85 has optical code 210 that contains information about the liquid additive contained in the reservoir which can be read by optical reader 202 of controller 26. That information can include information about temperature needed to effectively spray the additive, or can include information about the additive's viscosity as a function of temperature so that the controller can determine what temperature to use during spraying.

In the case where information is entered using an optical tag on the liquid additive reservoir 85, optical reader 202 does not have to be mounted on controller 202, but can be mounted where the reservoir is connected at the mechanical mixer to assure that the correct additive is being used in the powder coating composition. This is particularly beneficial when two or more liquid additive reservoirs are being used for a powder coating composition, for example using the embodiment shown in FIG. 6, so as to confirm which additive reservoir is connected to which connector.

Also while an optical information communication means is shown in FIG. 7, other communication means may be used. For example additive reservoir 85 may have a magnetic or radio frequency RF tag that may be reprogrammed each time the reservoir is cleaned and/or refilled, and controller 26 can have an magnet tag or RF tag reader to read the reservoir. If reservoir 85 is refilled with a specific amount of additive for a particular powder coating composition blend, the tag can be programmed with additive type and additive volume information that is used by controller 26. Further, controller 26 may have a magnetic or RF read/write capability that as additive is removed from a reservoir 85 with additive volume for multiple composition blends, the controller can rewrite the tag to reflect the remaining volume. In that manner, the controller can determine whether reservoir 85 contains sufficient additive volume before the mechanical mixing of a specific powder coating composition is started.

At the end of the mechanical mixing process, controller 26 can document the liquid additive addition process. The documentation can be the form of an internal file that can be downloaded at the end of every powder coating composition batch or at periodic intervals. The documentation can be provided using output 206 to printer 208, fixed communication conduit 204 to a remote location, or using portable equipment (not shown) that can be connected to controller 26 for periodic downloads. In any case, the outputted information can be tailored to meet the documentation needs of the of the invention user.

Although FIGS. 1-7 are illustrated here as separate embodiments the elements of FIGS. 1-7 are interchangeable to form still further embodiments. U.S. Pat. No. 6,066,601 provides details on the chemical composition, preparation procedures, physical characterization and application of powder coatings. These teachings are incorporated by reference into this application.

### EXAMPLES

The following two examples demonstrate how the addition of liquid additives to a powder coating or other fine particulate polymer composition by the method and apparatus of the present invention provides benefit compared to conventional liquid additive addition methods.

### Example 1

The first example illustrates the difference between adding a liquid additive on a silica carrier (Lanco™ P10) and adding the same active chemical as a liquid additive (Lanco™ Flow U) using the present invention. Lanco™ Flow U is an acrylic flow modifier sold by The Lubrizol Corporation, Wickliffe, Ohio. Lanco Flow P10 is the same additive adsorbed into a silica carrier and sold by the Lubrizol Corporation. The weight of additive is expressed on an active chemical ingredient basis (i.e. the weight of the silica carrier for P10 is ignored) divided by the weight of the formulated powder coating (the coating plus the Lanco Flow U or Lanco P10).

The Lanco Flow U is known for improving flow and leveling of powder coating. In particular, Lanco Flow U is used in a powder coating where high gloss at 20° and 60°, a high distinctness of image (DOI), and no craters are desired.

For this example, a clear polyester urethane coating composition with the components shown in Table 1 was used. For reference, Uraflow B is benzoin, Ruco 112 Polyester is a hydroxy functional polyester with a hydroxyl number 30 and an acid number of 6. Ruco NI-2 is an isophorone diisocyanate adduct blocked with epsilon caprolactum. Uraflow B, Ruco 112 Polyester and Ruco NI-2 are available from Ruco Polymer Corp., Hicksville, N.Y. The additive was either the powder Lanco Flow P10 or the liquid Lanco Flow U described above. For the compositions with additive, the amounts of Ruco 112 and Ruco NI-2 were proportionately reduced so that the final composition including the silica weight, if Lanco P10 was used, totaled 100 parts by weight.

TABLE 1

| Component | Parts by Weight |
|---|---|
| Uraflow B | 0.4 |
| Ruco 112 Polyester | 86.66 |
| Ruco NI-2 | 12.94 |
| Additive | Variable |

Table 2 lists the 20° and 60° gloss, the DOI, haze, and the number of craters observed on coated 4″×12″ test panels for compositions with no additive, with solid powder Lanco Flow P10 (P10) using conventional dry bending, and with liquid additive Lanco Flow U (U) and the method and apparatus of the present invention. In all cases a Henschel FM-10 mechanical mixer was used with 1.5 kg total batch size. A mix cycle of 80 seconds at 1,000 rpm followed by 20 seconds at 2,000 rpm was used for all batches and the blended components were melt homogenized using a APV 19 mm twin screw extruder at 250 rpm, 110° C. zone 1 and 90° C. zone 2, immediately after mechanical mixing. The extrudate was fractured and ground using Reitsch mill and the panels sprayed with the powders and cured within 1 day of powder production. For compositions using Lanco Flow U, nitrogen-gas assisted spray nozzle with a 0.060″ orifice was used. The gas flow rate was held fixed at 19.8 liter per minute during spraying. The Lanco Flow U was heated to 110° C. before spraying. Spraying began within two seconds after starting of the mixer at 1,000 rpm, and the additive flow rate set to complete spraying the additive in approximately 55 seconds independent of the additive amount, allowing for approximately 20 seconds of low speed mixing after spray addition before the 20 seconds of high speed mixing. The 20° and 60° gloss were measured with an industry standard BYK trigloss meter, and DOI was measured with and industry standard ATI meter. The haze was determined visually, and all craters on the test panel were counted.

TABLE 2

| | | Wt. | 20° | 60° | | | |
|---|---|---|---|---|---|---|---|
| Sample | Additive | % | Gloss | Gloss | DOI | Haze | Craters |
| A | None | 0.0 | 75 | 115 | 45 | None | Covered |
| B | P10 | 0.2 | 149 | 141 | 99 | None | Many |
| C | P10 | 0.5 | 145 | 138 | 99 | Strong | 2-very small |
| D | U | 0.2 | 146 | 141 | 99 | None | 2-very small |
| B | U | 1.0 | 147 | 141 | 85 | None | None |

The table shows that when no additive is used in sample “A”, the coating had poor 20° and 60° gloss, poor distinctness of image, and the test panel was covered with craters. When 0.2% of the Lanco Flow P10 was added in sample “B”, the 20° and 60° gloss, and the distinctness of image improved to acceptable values; however, the number of craters was still not acceptable. In sample “C”, where 0.5% Lanco Flow P10 was added, the number and size of the craters were reduced to a marginally acceptable level; however, the test panel exhibited a strong haze. The haze is attributed to the silica of the Lanco Flow P10. As shown by sample “D”, adding only 0.2% of Lanco Flow U resulted not only in acceptable 20° and 60° gloss, and distinctness of image, but also the same crater improvement without the strong haze of the 0.5% level of Lanco Flow P10. Even at the 1% level of Lanco Flow U in sample “E”, there was no haze in the test panel coating, although the distinctness of image began to degrade at this high additive loading. Hence, the use of the method and apparatus of the present invention allowed a reduction of liquid additive needed to achieve acceptable test panel coating when compared to using a conventional method of first making a solid form by absorbing liquid additive onto silica.

There was no handling problem associated with preparing any of the compositions used to make the test panels of Table 2. Even using the method and apparatus of this invention when preparing the compositions of samples “D” and “E”, the Henschel mechanical mixers used to blend the composition components, came out clean without any build-up on the blades or walls of the mixer, so no additional clean-up was required. Also, the blended components from the mixer showed no lumping or stickiness, even at the 1% liquid additive level

### Example 2

The second example illustrates the difference between a liquid additive addition using the method and apparatus of the present invention and using the method of pouring a liquid additive through a port into a mechanical mixer as the solid components are being blended. The liquid additive in this example is a dispersant, LZ2176, used to improve homogenization of a color powder coating composition with at least one colored powder component while maximizing extruder throughput. Table 3 lists the components of the white powder coating composition used to study color homogenization and extruder throughput. For reference, Uraflow B is the benzoin used in composition of Table 2. UCB 440 is a carboxy functional polyester with an acid number 33±3, and DPP Red BO is a red pigment available from Ciba Geigy in Switzerland. Nuitang TGIC is a triglycidyl isocynate. R-960 Titanium Dioxide is a white pigment made by Dupont. Lanco Flow P10 is the solid particulate version of the flow modifier used in the Example 1 and is sold by The Lubrizol Corporation, and LZ 2176 is a liquid dispersant sold by The Lubrizol Corporation. When liquid additive was included in the composition, the UCB 440 and Nuitang TGI were proportionately reduced so that the final composition remained 100 parts by weight.

TABLE 3

| Component | Parts by Weight |
|---|---|
| Uraflow B | 0.4 |
| UCB 440 | 66.01 |
| DPP Red BO | 0.069 |
| Nuitang TGIC | 4.921 |
| R-960 Titanium Dioxide | 27.83 |
| Lanco Flow P10 | 0.7692 |
| LZ 2176 | Variable |

Table 4 lists the extruder throughput of an APV 19 mm twin screw extruder in steady-state operation at 300 rpm and 110° C. in both zone 1 and 2, and the color value of coated test panels for compositions with no dispersant added, with dispersant added by pouring, and with dispersant added by the method and apparatus of this invention. In all cases, a Henschel FM-10 mechanical mixer was used with a 1.5 kg total batch size. The mechanical mixing cycle was 1 minute at 1000 rpm followed by 1 minute at 2,000 rpm. For the compositions where the liquid additive was poured into the mixer, the additive was at room temperature (approximately 23° C.) and was added with the mixer stopped between the 1 minute of low speed mixing and the 1 minute of high speed mixing. For the composition where the liquid additive was sprayed into the mixer, a nitrogen-gas assisted spray nozzle with a 0.060″ orifice was used. The gas flow rate was held fixed at 19.8 liter per minute during spraying. Room temperature additive was sprayed beginning within two seconds after starting of the mixer at 1,000 rpm, with a flow rate that required approximately 55 seconds to spray the total additive amount. Throughputs were calculated from weighed samples of extruder output, and color was measured using an industry standard Hunter Lab. Spectrometer and the numbers listed are the L-values (degree of lightness/darkness) of the “L,a,b” color space.

TABLE 4

| | Wt. % | Addition | Throughput | Color |
|---|---|---|---|---|
| Sample | Additive | Method | (pound/hour) | (L Value) |
| F | 0.0 | — | 16.5 | 89.2 |
| G | 0.75 | Pour | 19.8 | 87.4 |
| H | 1.5 | Pour | 32.8 | 88.3 |
| I | 0.75 | Invention | 31.4 | 89.3 |

The table shows that when no additive is used in sample “F”, extrusion throughput was relatively low and color was relatively good. Using the conventional method of pouring the liquid additive into the mechanical mixer the extrusion throughput increased by 20% but the color decreased of 1.8 points when 0.75% of the liquid was used for sample “G”, and extrusion throughput increase by almost 100% but the was still down by 0.9 points when 1.5% of the liquid additive was used for sample “H”. Using the method and apparatus of the present invention, sample “I” showed a 0.75% liquid additive addition increased extrusion rate by 90% extrusion rate increase with essentially no change in color. Hence, the method and apparatus of the present invention allowed a significant reduction of the liquid additive needed to achieve a specific extrusion throughput increase while maintaining color when compared to a conventional method of pouring the liquid additive into the mechanical mixer during blending.

While particular embodiments of the present invention (such as shown in FIGS. 1-7) have been shown and described, and specific examples given, it is apparent that various combinations, changes and modifications may be make therein to fit the needs of various mechanical mixers, liquid additives, and other processing equipment or of various powder coating composition without departing from the invention in its broadest aspects.

What is claimed is:

1. A process for distributing a liquid additive to a granulated or particulate powder coating composition comprising; spraying a liquid additive as small droplets onto a granulated or particulate premix composition while the premix composition is mechanically blended.

2. A process according to claim 1 wherein the liquid additive comprises a powder coating transfer-efficiency modifying agent, a melt flow modifier, leveling agent, adhesion promoter, corrosion inhibitor, metal passivator, dispersing aid or combinations thereof.

3. A process according to claim 1 or 2, wherein said liquid additive is in neat form and does not include non-reactive diluents added to reduce application viscosity of the liquid additive.

4. A process according to claim 1, 2, or 3; wherein said small droplets have a number average particle diameter from about 1 to about 200 microns.

5. A process according to claim 1, wherein the liquid additive is sprayed from an apparatus comprising
a) an additive reservoir,
b) a spray nozzle used to dispense said additive and connected to said reservoir,
c) a flow metering device connected to said reservoir or between said reservoir and said spray nozzle so that the amount of liquid additive dispensed is measurable by said device,
d) a controller that controls the amount and/or rate liquid additive sprayed by the apparatus.

6. A process according to claim 5, wherein the reservoir is pressurized to force the liquid additive from the reservoir, through the flow metering device and into said spray nozzle.

7. A process according to claim 5, wherein said apparatus includes at least one plunger type device that controls the flow rate of liquid additive to the spray nozzle.

8. A process according to claim 5 wherein said apparatus includes a pump that controls the flow rate of liquid additive to the spray nozzle.

9. A process according to claims 5, 6, 7 or 8, wherein said additive reservoir is so designed to be mechanically detached from said apparatus without substantial leakage of said additive.

10. A process according to claims 5, 6, 7, 8 or 9, wherein said additive reservoir is labeled with a bar code or other electronically readable marking identifying the additive composition, contents, and/or predetermined spraying conditions.

11. A process according to claims 5, 6, 7, 8, 9 or 10, wherein said spray nozzle is an airless nozzle.

12. A process according to 5, 6, 7, 8, 9 or 10, wherein said spray nozzle is a gas assisted spray nozzle.

13. A process according to claim 12, wherein said controller controls either the gas flow rate and/or the gas pressure to said gas assisted spray nozzle.

14. A process according to any of claims 5-12, wherein said liquid additive is heated to a temperature at least 5° C. warmer than the temperature in the reservoir before it is sprayed from said spray nozzle.

15. A process according to any of claims 5-12 wherein said liquid additive is heated to a temperature at least 25° C. warmer at said spray nozzle than at said liquid additive reservoir.

16. A process according to any of claims 5-15 wherein said controller controls the temperature of said liquid additive at the spray nozzle.

17. A process according to any of claims 5-16, wherein the volume of said apparatus between said reservoir and said spray head is less than 5% of the volume of said liquid additive reservoir.

18. A process according to any of claims 5-16, wherein the volume of said apparatus between said reservoir and said spray head is less than 1% of the volume of said liquid additive reservoir.

19. A process according to claim 7, wherein said plunger type device pumps said liquid additive through said apparatus in addition to metering the flow rate of said liquid additive through said apparatus.

20. A process according to claims 7 or 19, wherein said plunger type device is configured so that the plunger moves in said liquid additive reservoir to force liquid additive out of said spray nozzle.

21. A process according to any of claims 5-20, wherein said controller controls the spray conditions to achieve an optimal spray particle diameter.

22. A process according to claims 5-20, wherein said controller can store, display or print the spraying conditions subsequent to said process for process documentation purposes.

23. A process according to any of claims 1-7, wherein the volume of additive that is contained in said flow meter, said spray head and any tubing or voids interconnecting said flow meter and spray head is less than 5% of the volume the additive material reservoir.

24. A process according to any of claims 1-7, further including at least one heating device to increase the temperature of the liquid additive and a temperature controller to control the amount of temperature increase.

25. A process according to any of claims 1-7, wherein said reservoir is coupled to said flow meter with at least a mechanical disconnect point, whereby said reservoir can be disconnected from said flow meter without substantial leakage of said additive.

26. A process according to any of claims 1-6, wherein said device includes a programmable controller that can receive external input and from that input control the amount and/or rate of liquid additive addition.

27. A process according to any of claims 1-6, wherein said additive is sprayed as droplet having a weight average particle size of less than 40 microns in diameter.

28. A process according to claim 1, wherein said additive is added to said powder coating composition in an amount from about 0.05 to about 5 weight percent based on the weight of said powder composition.

29. A process for forming a powder coating composition including the steps of
a) mixing a binder resin with one or more other components to the coating in a dry mixer forming a premix,
b) melt mixing the premix forming it into a molten mass,
c) cooling the molten mass below its softening temperature so it can be fractured, and
d) fracturing the cooled molten mass into a granular powder, the improvement comprising spraying a liquid additive onto the binder resin during the dry mixing portions of step a).

30. A process for distributing a liquid additive into a granulated or particulate powder coating premix composition comprising spraying a liquid additive as droplets onto said premix composition as it is being mechanically mixed, said spraying being from an apparatus including
a) an additive reservoir,
b) a spray nozzle used to dispense said additive and connected to said reservoir,
c) a flow metering device connected to said reservoir or between said reservoir and said spray nozzle so that the amount of liquid additive dispensed is measurable by said device,
d) a controller that controls the amount and/or rate liquid additive sprayed by the apparatus.
